(19) United States
(12) Patent Application Publication
(10) Pub. No.: US 2015/0377263 A1
(43) Pub. Date: Dec. 31, 2015

(54) Method for Producing a Component Comprising a Position Measuring System

(71) Applicant: Robert Bosch GmbH, Stuttgart (DE)

(72) Inventors: Leo Dupuis, 's-Hertogenbosch (NL); Roy Orbon, Beek en Donk (NL); Leo Caspers, Eindhoven (NL); Pim van Oevelen, Riethoven (NL)

(21) Appl. No.: 14/751,293

(22) Filed: Jun. 26, 2015

(30) Foreign Application Priority Data
Jun. 27, 2014 (DE) 10 2014 212 382.8

(51) Int. Cl. F15B 15/28; B23K 26/342; B23K 26/03; B32B 15/01

(52) U.S. Cl. CPC F15B 15/2846; B32B 15/01; B23K 26/342; B23K 26/032

(57) ABSTRACT

A piston rod defining a surface and including a structure on the surface configured to be traced by a position sensor during a stroke of the piston rod. The surface, and consequently the structure, are covered by a coating by buildup welding. The structure is produced in the same operation during the buildup welding of the coating. The entire structure may be formed by the buildup welding, or a coded basic profile is incorporated before the buildup welding.

This application claims priority under 35 U.S.C. §119 to patent application no. DE 10 2014 212 382.8, filed on Jun. 27, 2014 in Germany, the disclosure of which is incorporated herein by reference in its entirety.

The disclosure relates to a translatory position measuring system for a moved component and to a method for producing the component comprising the position measuring system.

### BACKGROUND

When there is movement and positioning of a moved component of a technical device—in relation to another component that is usually at rest—sensing of the position and reporting back of this position to a control unit is often required in order to control the drive of the moved component. Such a device is for example a piston with a piston rod, which are moved in relation to a hydraulic cylinder.

The documents EP 0 618 373 B1 and DE 101 19 941 A1 respectively show a position measuring system for a piston rod in which the piston rod is produced from a magnetically conductive metallic base material, incorporated in the surface of which are circumferential grooves that form a profile. The movement of the profile, and consequently of the piston rod, can be sensed by a sensor fastened to the cylinder. The surface, and consequently the profile, are covered by a protective layer that is less conductive than the base material or is not conductive. The protective layer fills the grooves and forms a smooth outer surface of the piston rod on which for example sliding rings can slide. In EP 0 618 373 B1, this protective layer is a thin ceramic layer that is finished by grinding or honing.

These protective layers are typically thermally sprayed. The strength of the connection between the protective layer and the base material or the profile is based (only) on force-fitting engagement and is therefore less than optimum. Furthermore, on account of the principle concerned, such protective layers have pores, which impair the corrosion resistance of the piston rod, in particular if it is produced from a low-alloy steel, and its chemical resistance.

The document WO 2011/116054 A1 discloses a position measuring system for a piston rod in which the grooves of the main body of the piston rod are filled with a first layer, which consists of a so-called indicator material 22. Then, the entire piston rod is covered with a second corrosion protection layer (corrosion resistant cladding 44). Both layers are applied by laser buildup welding.

A disadvantage of such piston rods is that the application of the two layers involves in principle a great amount of effort. Laser buildup welding of the first layer, which fills the grooves of the main body, without destroying the structure is only possible with very great effort. Then there is the effort for reworking the surface of the first layer to make its thickness more even before the second layer can be applied. If a measuring system integrated in the cylinder (CIMS Cylinder Integrated Measuring System) with high-performance error correction (for example according to EP 0 618 373 B1) is to be provided, an adaptation of the device must be carried out.

### SUMMARY

Against this background, the disclosure is based on the object of providing a method for producing a component comprising a position measuring system and providing such a component with which the durability of the coating is increased in comparison with the first-mentioned documents and the effort involved in production is reduced in comparison with the last-mentioned document.

This object is achieved by a method with the features described herein and by a position measuring system with the features described herein.

The method according to the disclosure serves for producing a structure on a surface of a main body of a component and for applying a coating to this surface. By way of the structure, a translatory movement can be traced by a position sensor (without direct contact). The coating that forms a protective layer is applied by buildup welding. In this case, the structure that is necessary for later position sensing of the installed component is produced by the process parameters being varied during the buildup welding. The structure is formed by unevennesses or changes in thickness—seen along the direction of movement—on the surface. Consequently, the coating is connected to the main body of the component by metallurgical material bonding, and therefore is strongly connected. In comparison with the prior art, this dispenses with the need for one of the two welding steps, and possibly reworking of the first layer. The metallurgically material-bonded connection of the coating to the main body also means that later working or repair of the component in the installed state or during operation is possible.

The varied parameter may be the current with which the buildup welding is made possible or is performed.

In the case of a first variant of the production method according to the disclosure, the main body is not provided in advance with a coded basic profile, thereby dispensing with the need for a laborious production step of the prior art. As a result, the notch effect of the basic profile, which is usually formed by grooves, is also avoided. Consequently, the structure is comparatively flat and can be sensed later by a stroke-independent (for example external) position sensor. In the case of the first variant, therefore, the coating is applied with a comparatively constant thickness.

In the case of a second variant of the production method according to the disclosure, a coded basic profile is mechanically incorporated in the surface (for example by machining) in advance. This basic profile preferably has regular or irregular grooves, which are preferably incorporated transversely in relation to the direction of the movement.

The buildup welding is preferably laser buildup welding.

In the case of a particularly preferred development, thermographic imaging (preferably of the state and the size) of the molten material is performed during the laser buildup welding by way of a camera, the power supply to the laser being set in dependence on the imaging.

Since in the case of the second variant and in the case of the refinement with the laser buildup welding the size of the laser spot influences the deviations or changes of the basic profile that are produced by the laser buildup welding, it is particularly preferred if the size of the laser spot is adapted to a geometry (for example depth of a groove) of the basic profile.

In the case of a preferred development of the two variants of the production method, the coating is (at least partially) melted again. In this way, defects of the surface of the main body can be removed. The structure can also be smoothed. This preferably takes place with a further laser.

A surface of the coating is preferably reworked, for example by precision turning, honing or grinding. If the coating has been melted again before the reworking, this reworking is simplified. A shorter reworking time is achieved by the surface that has already been smoothed as a result of the melting, with at the same time a reduction in the material to be removed.

Since the coating applied according to the disclosure is free from pores, the main body of the component can be produced in advance from a low-cost low-alloy steel, and can consequently be optimally protected from corrosion.

To optimize the readability of the structure by the position sensor, a limited iron content of the coating should be observed.

The claimed component has a main body, which has on its surface—seen along the direction of its translatory movement—a structure that can be sensed by a position sensor during the movement. The surface, and consequently the structure, are covered by a coating. According to the disclosure, the structure is at least partially produced during the buildup welding of the coating. The feature “at least partially” does not concern the extent of the structure in the direction of movement, but the height of the structure. Therefore, the entire structure may be formed by the buildup welding, or a coded basic profile was present before the buildup welding. In the case of both variants, the coating is connected to the main body of the component by metallurgical material bonding, and therefore is strongly connected. This dispenses with the need for one of the two welding steps of the prior art, and possibly reworking of the first layer. The metallurgically material-bonded connection of the coating to the main body also means that working or repair of the component in the installed state or during operation is possible.

In the case of a first variant of the component according to the disclosure, the main body does not have a coded basic profile, thereby dispensing with the need for a laborious production step of the prior art. As a result, the notch effect of the basic profile, which is usually formed by grooves, is also avoided. In the case of a first variant, the coating has a comparatively constant thickness. Consequently, the structure is comparatively flat and can be sensed by a stroke-independent (for example external) position sensor.

In the case of a second variant of the component according to the disclosure, a fundamental coded basic profile is formed on the surface. This is preferably formed by regular or irregular grooves, which are preferably incorporated transversely in relation to the direction of the translatory movement.

The structure and the coating are preferably produced by laser buildup welding.

Since the size of the laser spot influences the deviations or changes of the basic profile that are produced by the laser buildup welding, it is preferred if a size of the laser spot has been adapted to a geometry of the basic profile.

The surface of the coating has preferably been reworked.

Since the coating according to the disclosure is free from pores, the main body of the component may consist of a low-cost low-alloy steel, and can consequently be optimally protected from corrosion.

To optimize the readability of the structure by the position sensor, the component should have a limited iron content of the coating.

In the case of a particularly preferred application of the component according to the disclosure, it is a piston rod.

Then, the position sensor can be integrated in the assigned cylinder (CIMS Cylinder Integrated Measuring System).

In the case of a preferred development, the position sensor in conjunction with the structure is programmed with advanced error correction, the structure being based on the coded basic profile according to the second variant.

### BRIEF DESCRIPTION OF THE DRAWINGS

Various exemplary embodiments of the disclosure are described in detail below with reference to the figures, in which:

FIG. 1 shows a first exemplary embodiment of a piston rod according to the disclosure after a first production step;

FIG. 2 shows the piston rod according to FIG. 1 after a second production step; and

FIG. 3 shows the piston rod according to FIGS. 1 and 2 after a third production step in the installed state.

### DETAILED DESCRIPTION

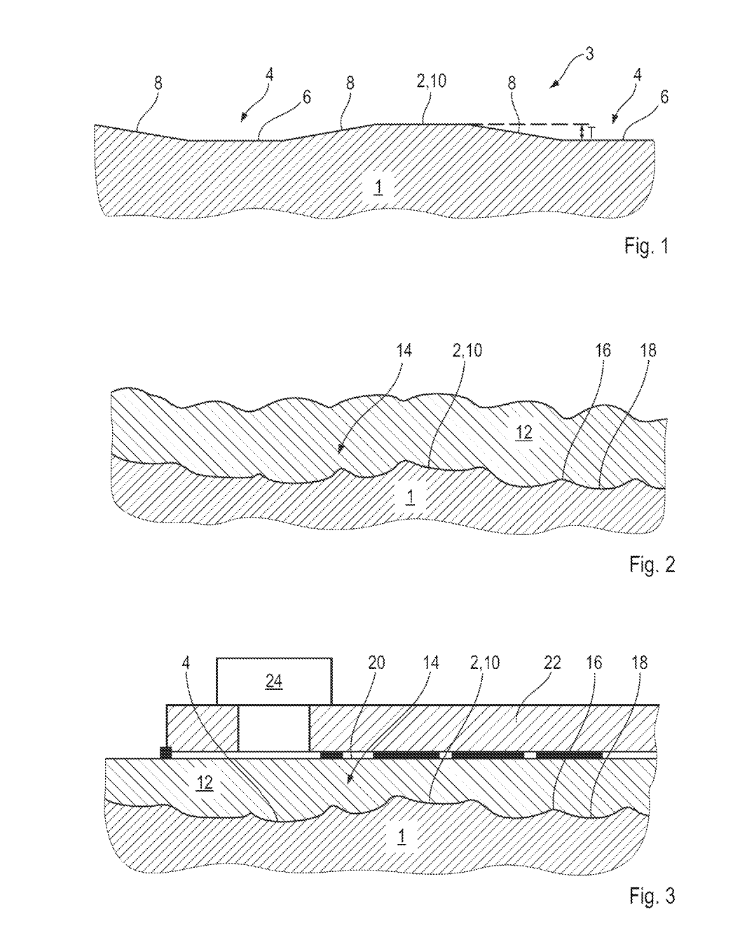

FIG. 1 shows a detail of a main body 1 of a piston rod in a longitudinal section. The main body 1 was produced from a low-alloy steel. After that, a basic profile 3 was produced on a surface 2 of the piston rod or of the main body 1 in a machining process. The basic profile 3 has along the piston rod uniformly recurring, comparatively wide and flat grooves 4. Each groove 4 has a peripheral groove base 6 and two lateral peripheral flanks 8. Arranged between two flanks 8 is a web 10 of the surface 2. The axial extent of the groove bases 6 and of the webs 10 is the same. A groove 4 and a web 10 together have a radial extent of for example 100 mm. The grooves 4, and consequently the basic profile, have or has a depth T of for example 0.25 mm.

FIG. 2 shows the detail of the piston rod from FIG. 1 after a further production step. A coating 12 was provided on the surface 2 by buildup welding by means of a laser. This coating has a comparatively low iron content, in order to make later tracing of the surface 2 by a magnetic position sensor possible.

During the buildup welding of the coating 12, the basic profile 3 (compare FIG. 1) was attacked and changed, so that the grooves 4, the flanks 8 and the webs 10 of the basic profile 3 have now been overlaid with a structure 14 that is formed by radial elevations 16 and radial depressions 18.

FIG. 3 shows the piston rod after precision working of the surface 20 of the coating 12, the piston rod being accommodated in a guide of a cylinder 22. Integrated in the cylinder 22 is a position sensor 24. In this way, the Cylinder Integrated Measuring System (CIMS) is formed. An electronic evaluation unit (not shown any more specifically) is connected for signaling purposes to the position sensor 24 and is programmed in such a way that, in spite of the changes caused by the buildup welding, the position measuring system thus formed can detect the grooves 4 and webs 10 of the original basic profile 3 (cf. FIG. 1), and so can determine the position of the piston rod in relation to the cylinder 22.

A piston rod which has on its surface a structure that is traced by a position sensor during the stroke is disclosed. The surface, and consequently the structure, are covered by a coating by buildup welding. The structure is produced in the same operation during the buildup welding of the coating. The entire structure may be formed by the buildup welding, or a coded basic profile is incorporated before the buildup welding.

### LIST OF DESIGNATIONS

1 main body
2 surface
3 basic profile
4 groove
6 groove base
8 flank
10 web
12 coating
14 structure
16 radial elevation
18 radial depressions
20 surface
22 cylinder
24 position sensor
T depth

What is claimed is:

1. A method for applying a coating to a surface of a main body of a component and for producing a structure on the surface, the translatory movements of the structure being traceable by a position sensor, the method comprising:
producing the structure by applying the coating to the surface by buildup welding while at the same time varying process parameters.

2. The method according to claim 1, further comprising:
mechanically incorporating a coded basic profile in the surface in advance of producing the structure, so that the process parameters need not be varied.

3. The method according to claim 1, further comprising:
performing the buildup welding with a laser.

4. The method according to claim 3, further comprising:
performing thermal imaging of molten material of the main body by way of a camera during the buildup welding; and
setting a power supply of the laser in dependence on the thermal imaging.

5. The method according to claim 3, further comprising:
mechanically incorporating a coded basic profile in the surface in advance of producing the structure, so that the process parameters need not be varied; and
adapting a size of a laser spot formed by the laser to a geometry of the coded basic profile.

6. The method according to claim 1, further comprising:
at least partially melting the coating again.

7. The method according to claim 1, further comprising:
reworking a surface of the coating.

8. The method according to claim 1, further comprising:
producing the main body from a low-alloy steel.

9. A component comprising:
a main body defining a surface covered by a coating; and
a structure located on the surface, the structure configured to be traced by a position sensor during movement of the main body, the structure at least partially produced by buildup welding of the coating during the buildup welding of the coating.

10. The component according to claim 9, further comprising:
a coded basic profile formed on the surface.

11. The component according to claim 9, wherein the main body is at least partially formed from a low-alloy steel.

12. The component according to claim 9, wherein the component is a piston rod.

13. A cylinder-piston arrangement comprising:
a cylinder;
a position sensor associated with the cylinder; and
a piston rod at least partially located in the cylinder and defining a surface, the surface including a structure configured to be traced by the position sensor during movement of the piston rod, the surface covered by a coating, and the structure at least partially produced (i) by buildup welding of the coating, and (ii) during the buildup welding of the coating.

14. The cylinder-piston arrangement of claim 13, wherein:
a coded basic profile is formed on the surface,
the piston rod is at least partially formed from a low-alloy steel,
the position sensor is integrated in the cylinder, and
the position sensor in conjunction with the structure based on the coded basic profile are configured for advanced error correction.
